(19) United States
(12) Patent Application Publication
(10) Pub. No.: US 2024/0336057 A1
(43) Pub. Date: Oct. 10, 2024

(54) THERMAL TRANSFER PRINTING DEVICE

(71) Applicant: HUNAN SIJIU TECHNOLOGY CO.,LTD, Changsha (CN)

(72) Inventors: WENXIONG HUANG, Changsha (CN); MIN AI, Changsha (CN)

(21) Appl. No.: 18/746,533

(22) Filed: Jun. 18, 2024

Related U.S. Application Data
(63) Continuation of application No. PCT/CN2023/074773, filed on Feb. 7, 2023.

(30) Foreign Application Priority Data
Feb. 25, 2022 (CN) 202220404501.6

(51) Int. Cl. B41F 16/00; B66B 7/02

(52) U.S. Cl. CPC B41F 16/0046; B66B 7/024

(57) ABSTRACT

The present invention relates to the technical field of thermal transfer printing equipment, and particularly to a thermal transfer printing device, comprising a body, a hot pressing plate assembly, a bracket and a pad; the body comprises an upper support and a lower support that extend horizontally; the hot pressing plate assembly is arranged below the upper support and driven by the drive mechanism to move up and down; the bracket is arranged on the upper side of the lower support to provide support for materials to be heat-transfer printed; the pad is arranged in the pad placement area and positioned by the positioning protrusions. The positioning protrusions on the edge of the bracket can effectively position the pad to prevent the dislocation between the pad and the bracket, which is simple in structure and convenient in operation.

### CROSS-REFERENCE TO RELATED APPLICATIONS

This application is a continuation of co-pending International Patent Application No. PCT/CN2023/074773, filed on Feb. 7, 2023, which claims the priority and benefit of Chinese patent application number 202220404501.6, filed on Feb. 25, 2022 with China National Intellectual Property Administration, the entire contents of which are incorporated herein by reference.

### TECHNICAL FIELD

The present invention relates to the technical field of thermal transfer printing equipment, and particularly, to a thermal transfer printing device, especially the improvement of the bracket.

### BACKGROUND

At present, existing thermal transfer printing machines are generally hydraulic or pneumatic type with complex structure and heavy weight. To solve the problems, some manufacturers have designed a motor-driven solution, by which this type of thermal transfer printing device comprises a body, a base, a bracket and a hot pressing plate assembly, wherein the bracket is arranged on the base, and a pad is generally placed on the bracket to improve the air permeability and hot-pressing effect.

For existing thermal transfer printing machines, the pad is generally placed directly on the working plate, which is prone to cause dislocation, and some manufacturers fix them by connector, which is not easy to operate.

### SUMMARY

The purpose of the present invention is to solve the problem of easy dislocation and difficult operation of the pad due to direct placement or fixed connection of iton the bracket by arranging positioning protrusions on the periphery of the bracket to limit the pad.

The thermal transfer printing device comprises a body, a hot pressing plate assembly, a bracket and a pad; the body comprises an upper support and a lower support that extend horizontally; the hot pressing plate assembly is arranged below the upper support and driven by the drive mechanism to move up and down; the bracket is arranged on the upper side of the lower support to provide support for materials to be heat-transfer printed, wherein positioning protrusions are arranged on the upper side of the bracket edge, the positioning protrusions are enclosed to form a pad placement area; the pad is arranged in the pad placement area and positioned by the positioning protrusions, wherein the thickness of the pad is arranged to protrude from the upper surface of the positioning protrusions.

The positioning protrusions on the edge of the bracket can effectively position the pad to prevent the dislocation between the pad and the bracket, which is simple in structure and convenient in operation.

Preferably, the positioning protrusions are a circle of convex edges arranged around the edge of the bracket. This solution yields good structural strength and ease of manufacturing.

Alternatively, a plurality of the positioning protrusions are arranged in a circle around the edge of the bracket.

Preferably, the bracket is made of plastic, comprising the bracket body, the bracket wall edge extending downward along the periphery of the bracket body, and the reinforcing rib structure arranged on the underside of the bracket body, and the connection between the bracket wall edge and the bracket body protrudes upward and forms the positioning projections. The adoption of the above structure can enhance the structural performance and stability of the bracket.

Preferably, the bracket is connected to the lower support through two guide rail devices, the two guide rail devices enable the bracket to be pulled out and pushed in relative to the lower support, the two guide rail mounting convex walls corresponding to the mounting positions of the two guide rail devices are arranged on the underside of the bracket body, the bracket is connected to the guide rail devices through the two guide rail mounting convex walls, and the handle members are arranged on the front side of the two guide rail mounting convex walls. In addition to connecting the guide rail devices, the two guide rail mounting convex walls have a reinforcing effect.

Preferably, a plurality of the guide rail device connecting parts are arranged on the side of the guide rail mounting convex wall, the first vertical reinforcing ribs are arranged on the guide rail device connecting part, and the second vertical reinforcing ribs are arranged on the other side of the guide rail mounting convex wall relative to the guide rail device connecting part. With the above arrangement, the structural performance of the guide rail mounting convex wall is effectively improved, which enhances the stability of support and force transmission of the bracket.

Preferably, the reinforcing rib structure comprises the reinforcing ring arranged at the lower side edge of the bracket body and around the inner side of the bracket wall edge, the first reinforcing rib connecting the reinforcing ring and the bracket wall edge, the second reinforcing rib horizontally arranged in the reinforcing ring, and the third reinforcing rib vertically arranged in the reinforcing ring, the first vertical reinforcing rib and the second vertical reinforcing rib are connected with the second reinforcing rib in the corresponding position. With the above arrangement, the structural strength of the bracket body can be further improved.

Preferably, the handle member comprises the handle mounting wall extending downward from the front end of the two guide rail mounting convex walls, the handle structure is arranged on the handle mounting wall, the handle mounting wall is arranged on the outer side of the reinforcing ring, a plurality of the third vertical reinforcing ribs are arranged on the inner side of the handle mounting wall, and the third vertical reinforcing ribs are connected to the first reinforcing ribs in the corresponding position. In addition to connecting the handle structure, the handle mounting wall can reinforce the bracket body.

Preferably, a plurality of guide rail positioning protruding points are arranged on the guide rail device connecting part, and positioning holes are arranged on the guide rail device corresponding to the guide rail positioning protruding points. The guide rail positioning protruding points and the positioning holes play a role in positioning the guide rail devices and bearing force.

Preferably, it also comprises the guide rail devices and the metal frame of the lower support, an opening is arranged on the front side of the metal frame, the guide rail devices are connected to the opposite sides of the opening of the metal frame, and the lower side of the metal frame is connected to the lower support through the connector. The metal frame acts as a stable connection between the guide rail devices and the lower support.

### BRIEF DESCRIPTION OF DRAWINGS

FIG. 1 is a three-dimensional diagram of the thermal transfer printing device

FIG. 2 is a three-dimensional diagram of the pulled-out bracket of the thermal transfer printing device

FIG. 3 is a three-dimensional cross-sectional view of the thermal transfer printing device

FIG. 4 is a three-dimensional cross-sectional view of the drive mechanism

FIG. 5 is a three-dimensional diagram of a part of the drive mechanism

FIG. 6 is an explosion diagram of the bracket and the lower support

FIG. 7 is a three-dimensional diagram of the bracket in upward view

FIG. 8 is an explosion diagram of the bracket and the guide rail device in upward view

### DESCRIPTION OF EMBODIMENTS

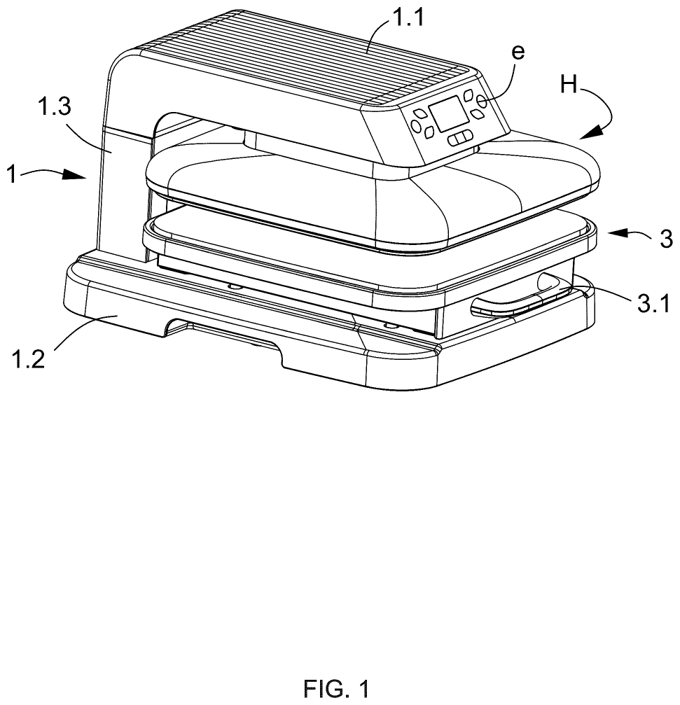

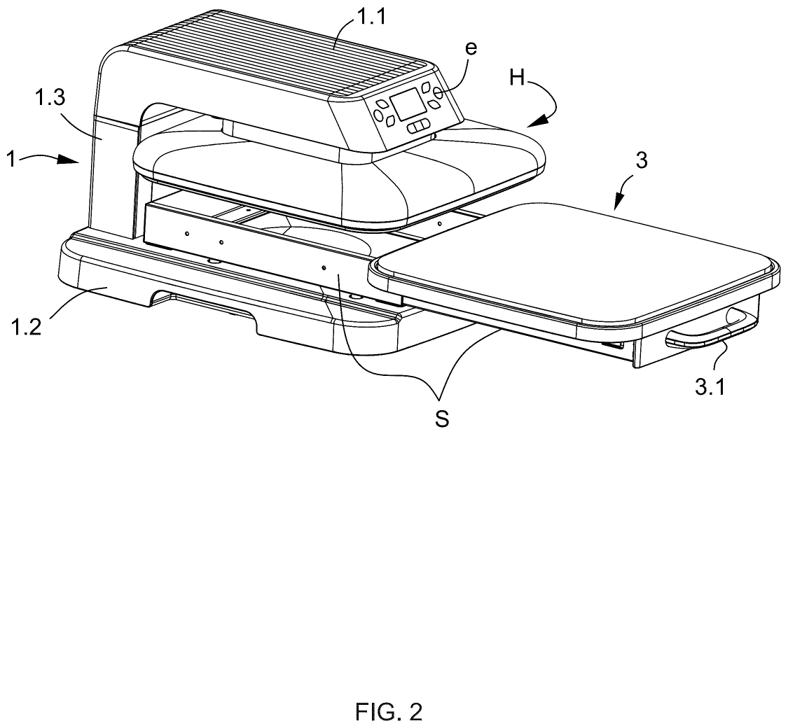

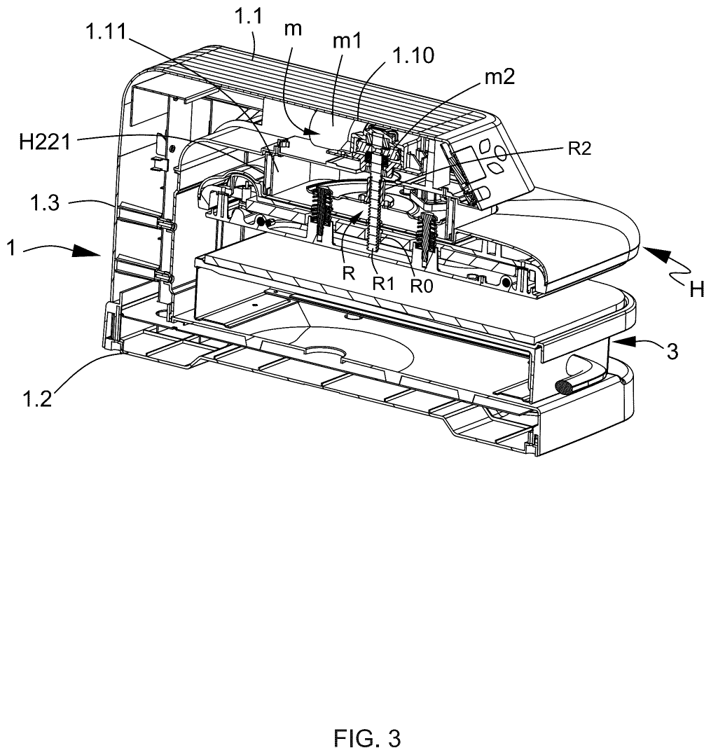

Referring to FIGS. 1 to 8, the thermal transfer printing device comprises the body 1, the hot pressing plate assembly 2, the bracket 3 and the pad d; the body 1 comprises the upper support 1.1 and the lower support 1.2 that extend horizontally; the hot pressing plate assembly H is arranged below the upper support 1.1 and driven by the drive mechanism m to move up and down; the bracket 3 is arranged on the upper side of the lower support 1.2 to provide support for materials to be heat-transfer printed, wherein the positioning protrusions 3.1 are arranged on the upper side of the bracket 3 edge, the positioning protrusions 3.1 are enclosed to form the pad placement area 3-d; the pad d is arranged in the pad placement area 3-d and positioned by the positioning protrusions 3.1, wherein the thickness of the pad d is arranged to protrude from the upper surface of the positioning protrusions 3.1. The positioning protrusions 3.1 on the edge of the bracket 3 can effectively position the pad d to prevent the dislocation between the pad d and the bracket 3, which is simple in structure and convenient in operation.

The positioning protrusions 3.1 are convex edges arranged in a circle around the edge of the bracket 3, which have good structural strength and are easy to manufacture.

The control area e is arranged on the front end surface of the upper support 1.1, and components for controlling the equipment, such as keys, touch screens, etc. are arranged in the control area e.

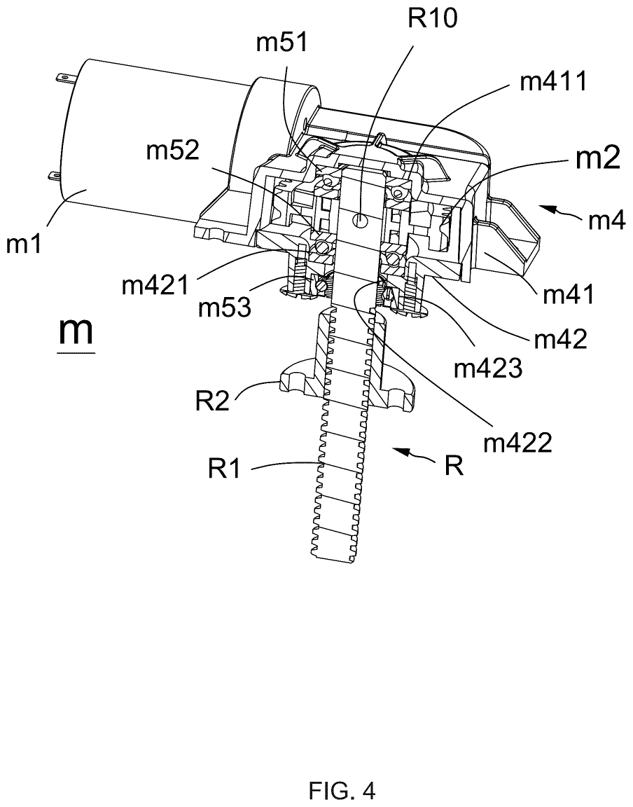

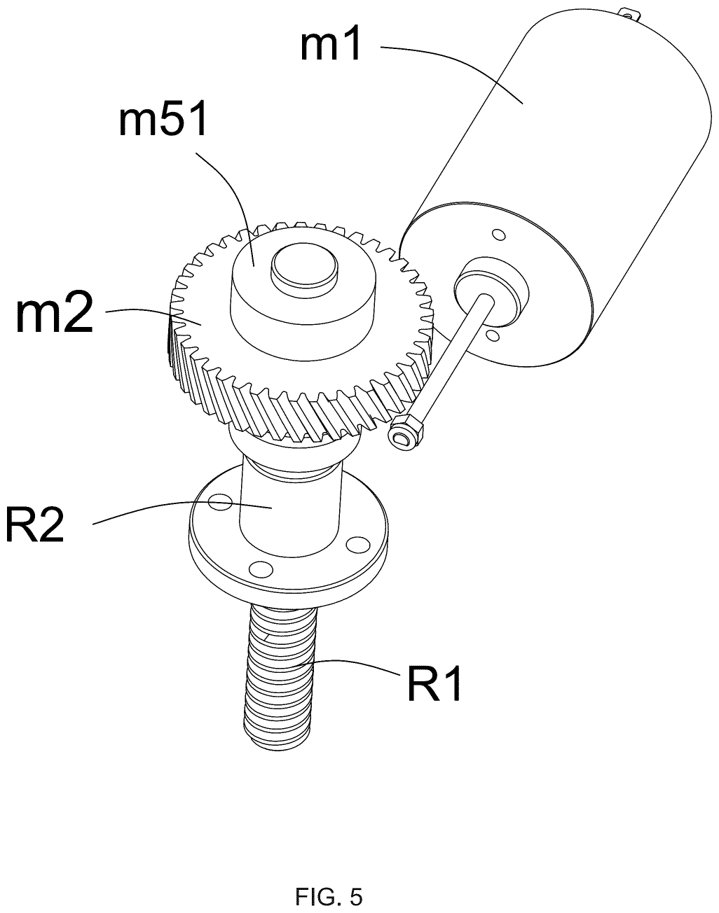

Referring to FIGS. 4 and 5, in one embodiment, the drive mechanism m comprises the motor m1, the reduction gear m2 and the drive gear member m3 mounted in the upper support 1.1, and the screw nut pair R, the upper end of the screw R1 is fixedly connected to the middle of the reduction gear m2; the middle of the hot pressing plate assembly H is fixedly connected to the nut R2 and is driven up and down by the rotation of the screw R1, and the screw avoidance channel R0 is arranged in the middle of the hot pressing plate assembly H.

In one embodiment, the gearbox m4 comprises the first box m41 and the second box m42 arranged up and down, the first bearing mounting part m411 is arranged on the inner wall of the first box m41, the corresponding second bearing mounting part m421 and the screw mounting hole m422 penetrating through the middle of the second bearing mounting part m421 are arranged on the inner wall of the second box m42, the upper end of the screw R1 penetrates the upper side of the reduction gear m2, and the first plane bearing m51 and the second plane bearing m52 are connected to the upper side and the lower side of the reduction gear m2 on the upper end of the screw R1, respectively, the first plane bearing m51 is mounted on the first bearing mounting part m411, and the second plane bearing m52 is mounted on the second bearing mounting part m421. On the upper end of the screw R1, by connecting the first plane bearing m51 and the second plane bearing m52 to the first box m41 and the second box m42, and mounting them in the first bearing mounting part m411 and the second bearing mounting part m421 using the axial support characteristics of the first plane bearing m51 and the second plane bearing m52, the screw R1 can be axially positioned, so that a universal screw R1 is available for better economy without installing an axial positioning mechanism on the screw R1.

In order to maintain the concentricity of the screw R1, the radial bearing m53 is arranged under the screw mounting hole m422, and the screw R1 is mounted on the radial bearing m53. The radial bearing m53 is a bearing whose coaxiality can be maintained, such as a roller bearing. For easy installation of the radial bearing m53, the third bearing mounting part m423 with a lower opening is arranged in the lower part of the screw assembly hole m422, and the radial bearing m53 is mounted in the third bearing mounting part m423 and fixed on the lower side by screws.

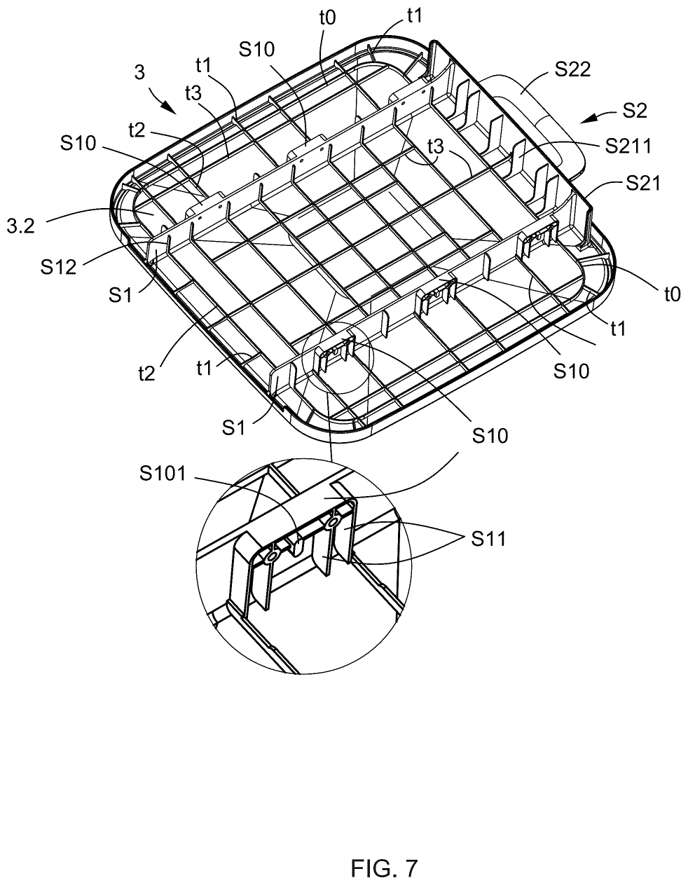

Referring to FIG. 7, the bracket 3 is made of plastic, comprising the bracket body 3.2, the bracket wall edge 3.3 extending downward along the periphery of the bracket body 3.2, and the reinforcing rib structure t arranged on the underside of the bracket body 3.2, and the connection between the bracket wall edge 3.3 and the bracket body 3.2 protrudes upward and forms the positioning projections 3.1. The adoption of the above structure can enhance the structural performance and stability of the bracket 3.

In other embodiments, a plurality of the positioning protrusions 3.1 can be arranged in a circle around the edge of the bracket 3.

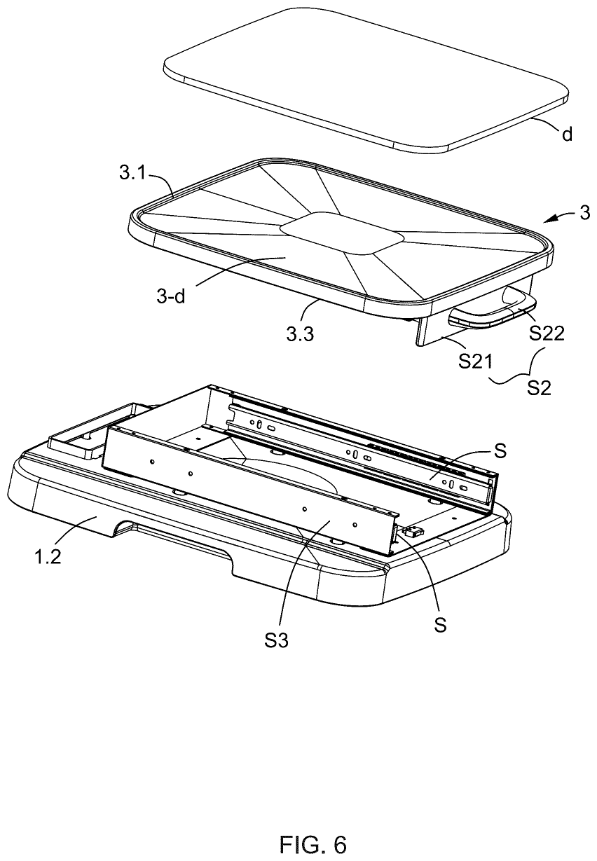

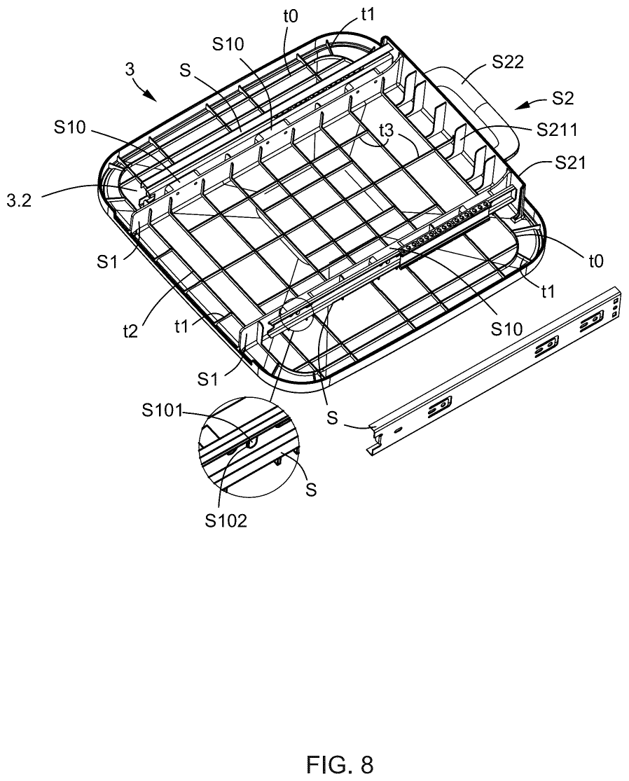

Referring to FIGS. 6 and 8. the bracket 3 is connected to the lower support 1.2 through the two guide rail devices S, the two guide rail devices S enable the bracket 3 to be pulled out and pushed in relative to the lower support 1.2, the two guide rail mounting convex walls S1 corresponding to the mounting positions of the two guide rail devices S are arranged on the underside of the bracket body 3.2, the bracket 3 is connected to the guide rail devices S through the two guide rail mounting convex walls S1, and the handle members S2 are arranged on the front side of the two guide rail mounting convex walls S1. In addition to connecting the guide rail devices S, the two guide rail mounting convex walls S1 have a reinforcing effect.

Referring to FIGS. 7 and 8, a plurality of the guide rail device connecting parts S10 are arranged on the side of the guide rail mounting convex wall S1, the first vertical reinforcing ribs S11 are arranged on the guide rail connecting part S10, and the second vertical reinforcing ribs S12 are arranged on the other side of the guide rail mounting convex wall S1 relative to the guide rail device connecting part S10. With the above arrangement, the structural performance of the guide rail mounting convex wall S1 is effectively improved, which enhances the stability of support and force transmission of the bracket 3.

The reinforcing rib structure t comprises the reinforcing ring t0 arranged at the lower side edge of the bracket body 3.2 and around the inner side of the bracket wall edge 3.3, the first reinforcing rib t1 connecting the reinforcing ring t0 and the bracket wall edge 3.3, the second reinforcing rib t2 horizontally arranged in the reinforcing ring to, and the third reinforcing rib t3 vertically arranged in the reinforcing ring t0, the first vertical reinforcing rib S11 and the second vertical reinforcing rib S12 are connected with the second reinforcing rib t2 in the corresponding position. With the above arrangement, the structural strength of the bracket body 3.2 can be further improved.

Referring to FIGS. 7 and 8, the handle member S2 comprises the handle mounting wall S21 extending downward from the front end of the two guide rail mounting convex walls S1, the handle structure S22 is arranged on the handle mounting wall, the handle mounting wall S21 is arranged on the outer side of the reinforcing ring t0, a plurality of the third vertical reinforcing ribs S211 are arranged on the inner side of the handle mounting wall S21, and the third vertical reinforcing ribs S211 are connected to the first reinforcing ribs t1 in the corresponding position. In addition to connecting the handle structure S22, the handle mounting wall S21 can reinforce the bracket body 3.2.

The handle structure S22 is a handle mounted on the front side of the handle mounting wall S21; in other embodiments, the handle structure S22 may also be integrally formed on the handle mounting wall.

Referring to FIGS. 7 and 8, a plurality of guide rail positioning protruding points S101 are arranged on the guide rail device connecting part S10, and positioning holes S102 are arranged on the guide rail device S corresponding to the guide rail positioning protruding points S101. The guide rail positioning protruding points S101 and the positioning holes S102 play a role in positioning the guide rail devices and bearing force.

Referring to FIGS. 6 and 8, it also comprises the guide rail devices S and the metal frame S3 of the lower support, an opening is arranged on the front side of the metal frame S3, the guide rail devices S are connected to the opposite sides of the opening of the metal frame S3, and the lower side of the metal frame S3 is connected to the lower support 1.2 through the connector S31. The metal frame acts as a stable connection between the guide rail device S and the lower support 1.2.

According to the disclosure and instructions of the above specification, the technical personnel in the field to which the present invention belongs may change and modify the above embodiments. The present invention is not limited to the specific embodiments disclosed and described above. Some modifications and changes to the present invention should fall within the scope of protection of the claims of the present invention.

What is claimed is:

1. A thermal transfer printing device, characterized in that it comprises:
a body, comprising an upper support and a lower support that extend horizontally;
a hot pressing plate assembly, arranged below the upper support and driven by the drive mechanism to move up and down;
a bracket, arranged on the upper side of the lower support to provide support for materials to be heat-transfer printed, wherein positioning protrusions are arranged on the upper side of the bracket edge, the positioning protrusions are enclosed to form a pad placement area;
a pad, arranged in the pad placement area and positioned by the positioning protrusions, wherein the thickness of the pad is arranged to protrude from the upper surface of the positioning protrusions.

2. The thermal transfer printing device according to claim 1, characterized in that the positioning protrusions are a circle of convex edges arranged around the edge of the bracket.

3. The thermal transfer printing device according to claim 1, characterized in that a plurality of the positioning protrusions are arranged in a circle around the edge of the bracket.

4. The thermal transfer printing device according to claim 1, characterized in that the bracket is made of plastic, comprising a bracket body, a bracket wall edge extending downward along the periphery of the bracket body, and a reinforcing rib structure arranged on the underside of the bracket body, and the connection between the bracket wall edge and the bracket body protrudes upward and forms the positioning projections.

5. The thermal transfer printing device according to claim 4, characterized in that the bracket is connected to the lower support through two guide rail devices, the two guide rail devices enable the bracket to be pulled out and pushed in relative to the lower support, two guide rail mounting convex walls corresponding to the mounting positions of the two guide rail devices are arranged on the underside of the bracket body, the bracket is connected to the guide rail devices through the two guide rail mounting convex walls, and handle members are arranged on the front side of the two guide rail mounting convex walls.

6. The thermal transfer printing device according to claim 5, characterized in that a plurality of guide rail connecting parts are arranged on the side of the guide rail mounting convex wall, first vertical reinforcing ribs are arranged on the guide rail connecting part, and second vertical reinforcing ribs are arranged on the other side of the guide rail mounting convex wall relative to the guide rail connecting part.

7. The thermal transfer printing device according to claim 6, characterized in that the reinforcing rib structure comprises a reinforcing ring arranged at the lower side edge of the bracket body and around the inner side of the bracket wall edge, a first reinforcing rib connecting the reinforcing ring and the bracket wall edge, a second reinforcing rib horizontally arranged in the reinforcing ring, and a third reinforcing rib vertically arranged in the reinforcing ring, the first vertical reinforcing rib and the second vertical reinforcing rib are connected with the second reinforcing rib in the corresponding position.

8. The thermal transfer printing device according to claim 7, characterized in that the handle member comprises a handle mounting wall extending downward from the front end of the two guide rail mounting convex walls, a handle structure is arranged on the handle mounting wall, the handle mounting wall is arranged on the outer side of the reinforcing ring, a plurality of third vertical reinforcing ribs are arranged on the inner side of the handle mounting wall, and the third vertical reinforcing ribs are connected to the first reinforcing ribs in the corresponding position.

9. The thermal transfer printing device according to claim 7, characterized in that a plurality of guide rail positioning protruding points are arranged on the guide rail device connecting part, and positioning holes are arranged on the guide rail device corresponding to the guide rail positioning protruding points.

10. The thermal transfer printing device according to claim 7, characterized in that it also comprises guide rail devices and a metal frame of the lower support, an opening is arranged on the front side of the metal frame, the guide rail devices are connected to the opposite sides of the opening of the metal frame, and the lower side of the metal frame is connected to the lower support through the connector.
